(19) United States
(12) Patent Application Publication
(10) Pub. No.: US 2005/0030908 A1
(43) Pub. Date: Feb. 10, 2005

(54) Method for identifying charging data records

(75) Inventors: Jens Lehmann, Falkensee (DE); Jens Schendel, Berlin (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munich (DE)

(21) Appl. No.: 10/887,322

(22) Filed: Jul. 9, 2004

(30) Foreign Application Priority Data
Jul. 11, 2002 (DE) 10332558.1

(51) Int. Cl. H04M 15/00; H04L 12/66; H04Q 11/00

(52) U.S. Cl. 370/265; 379/126

(57) ABSTRACT

A method for identifying charging data records which relate to a service use and are generated by various network elements in at least one telecommunication network. A data packet sequence associated with the service use is transferred between a service-using communication terminal and a service-providing service computer via the at least one telecommunication network using a service computer access gateway. This method involves a first network element generating a first charging data record, which includes charging information relating to the data packet sequence. The first network element assigns a first unique identifier to the first charging data record. First identifier information, which describes this first unique identifier, is transferred to an authorization network element via the service computer access gateway. The authorization network element then generates a data element from the “RADIUS” data transfer protocol, which contains this identifier information and which is unalterable after it has been generated.

This application claims the benefit of prior to German Application No. 103 325 558.1, filed in the German language on Jul. 11, 2003, the contents of which are hereby incorporated by reference.

### TECHNICAL FIELD OF THE INVENTION

The invention relates to a method for identifying charging data records which relate to a service use and are generated by various network elements in at least one telecommunication network.

### BACKGROUND OF THE INVENTION

Telecommunication subscribers in modern telecommunication networks are increasingly being offered a large number of services for use. Such service use involves a service computer (a service server, for example an internet server connected to the telecommunication network) transmitting a set of data to the communication terminal (e.g. film data, music data, message data, stock market prices, company news etc.), for example when requested by a communication terminal (e.g. mobile phone, personal digital assistant) (PDA) or portable computers with a mobile radio interface.

Such service use thus involves data being transferred in both directions between the communication terminal and the service-providing service computer. In modern telecommunication networks, such service use involves a data packet sequence (IP flow) being transferred in both directions between the communication terminal and the service computer in order to perform the data transfers. Such packet oriented data sequences arise in mobile telecommunication networks operating on the basis of the GPRS (General Packet Radio Service) or UMTS (Universal Mobile Telecommunication System) standard, for example. In order to invoice the service-using communication terminal or the operator thereof for service use, various network elements in the telecommunication network (or various network elements in a plurality of connected telecommunication networks involved in the service use) are able to generate charging data records (CDR). Since these network elements generate such charging data records independently of one another, these charging data records may each contain information which is already stored in other charging data records. There is therefore a need for a way of identifying those charging data records which contain information relating to a single service use. The intention is thus to identify data records which all relate to one particular service use.

### SUMMARY OF THE INVENTION

In one embodiment of the invention, there is a method for identifying charging data records which relate to a service use and are generated by various network elements in at least one telecommunication network, where a data packet sequence associated with the service use is transferred between a service-using communication terminal and a service-providing service computer via the at least one telecommunication network using a service computer access gateway, which method involves a first network element generating a first charging data record, which includes charging information relating to the data packet sequence, the first network element assigning a first unique identifier to the first charging data record, first identifier information, which describes this first unique identifier, being transferred to an authorization network element via the service computer access gateway, the authorization network element generating a data element from the “RADIUS” data transfer protocol, which includes the identifier information and which is unalterable after it has been generated, the data element being appended to a second charging data record, which is generated on account of the transmission of the data packet sequence to the service computer via the service computer access gateway, the first charging data record and the second charging data record being transferred to a data record identification node, the data record identification node reading the first identifier information from the data element in the second charging data record, and the first identifier information in the second charging data record and the first identifier in the first charging data record being used to identify that the first charging data record and the second charging data record are associated with one and the same service use. One particular advantage in this context is that the identifier information which uniquely describes the first identifier is packed into the unalterable data element from the “RADIUS” protocol. This allows the identifier information to be protected from unwanted alteration and allows it to be added to the second charging data record. The data record identification node can then use the data element and the first unique identifier for clearly identifying the first charging data record and the second charging data record; the two charging data records are identified as containing charging information about the one service use.

In another embodiment of the invention, the data element generated by the authorization network element is transferred to the service computer access gateway. Advantageously, the data element is then available at the service computer access gateway when transmission of the data packet sequence to the service computer via the service computer access gateway prompts the second charging data record to be generated.

In still another embodiment of the invention, the first charging data record generated is a first charging data record which contains the charging information about one data packet sequence and charging information about other data packet sequences which pass through the first network element and relate to the communication terminal in summed form. In this embodiment, the method may advantageously also make use of first network elements which are not capable of respectively ascertaining charging information on the basis of individual data packet sequences (i.e. on the basis of individual services), but rather are merely capable of ascertaining charging information about a plurality of data packet sequences in summed or combined form and writing them into a first charging data record.

In this case, the first charging data record can includes the charging information in the form of summed transfer time information and/or summed data volume information.

In yet another embodiment of the invention, the second charging data record generated is a second charging data record which includes charging information about the exact data packet sequence transferred between the communication terminal and the service computer. This means that the inventive method may advantageously also be used together with network elements which are capable of distinguishing between individual data packet sequences associated with a service and of providing charging information about one exact data packet sequence relating to one exact service and of writing it to charging data records.

In another embodiment of the invention, the second charging data record is generated by virtue of the transmission of the data packet sequence to the service computer via the service computer access gateway prompting the service computer access gateway to transmit the data element to a charging system, which generates the second charging data record and appends the data element to this second charging data record.

In this context, at the start and/or end of transfer of the data packet sequence the service computer access gateway can transmit to the charging system, together with the data element, transfer time information and/or data volume information relating to the data packet sequence, and the charging system can use this transfer time information and/or data volume information to generate the second charging data record. Using the two embodiments of the inventive method which have just been mentioned, it is advantageously possible and a very simple matter for the charging system to generate second charging data records as soon as the service computer access gateway identifies an individual data packet sequence and has ascertained data or charging information (transfer time information and/or data volume information) relating to this data packet sequence.

In still another embodiment of the invention, the second charging data record is generated by virtue of transmission of the data packet sequence to the service computer via the service computer access gateway prompting the service computer access gateway to transmit the data element to the authorization network element, which generates the second charging data record and appends the data element to this second charging data record.

In this context, at the start and/or end of transfer of the data packet sequence the service computer access gateway can transmit to the authorization network element, together with the data element, transfer time information and/or data volume information relating to the data packet sequence, and the authorization network element can use this transfer time information and/or data volume information to generate the second charging data record. In the two embodiments mentioned above, a separate charging system is advantageously not necessary in order to generate the second charging data record, but rather this second charging data record can be generated by the authorization network element which is normally present in communication networks anyway (for example an AAA server).

In yet another embodiment of the invention, setup and/or cleardown of a data tunnel for transferring one data packet sequence prompts the first network element to transmit to the authorization network element, together with the identifier, transfer time information relating to the data tunnel and/or data volume information relating to the data tunnel, and the authorization network element uses this transfer time information and/or data volume information to generate a third charging data record and assigns the identifier to this third charging data record. In this embodiment, the authorization network element is advantageously also used to generate a third charging data record, which includes transfer time information relating to the data tunnel and/or data volume information relating to the data tunnel. The invention also provides this third charging data record with the identifier so that the identification node is later able to identify that the charging data record is associated with the service use.

In another embodiment of the invention, the third charging data record is transferred to a data record identification node, the data record identification node reads the identifier from the third charging data record, and the identifier is used to identify that the third charging data record, the second charging data record and the first charging data record are associated with one and the same service use. Advantageously, the first network element used may be a “Serving GPRS Support Node” or a “Gateway GPRS Support Node”. This advantageously allows the inventive method to be used in a telecommunication network designed on the basis of GPRS (General Packet Radio Service) specifications.

The authorization network element used may be an “Authentication, Authorization and Accounting Server”. In this context, it is advantageous that the “Authentication, Authorization and Accounting Server” (AAA Server), which is already present in a large number of communication networks, can be used as the authorization network element.

In line with the invention, the first identifier information may comprise an address which identifies the first network element and an identity which identifies the data tunnel. This allows clear identification of the respective charging data records.

In line with the invention, the method may be in a form such that as the data element which includes the identifier information, the authorization network element generates a “class” data element designed on the basis of the “RADIUS” data transfer protocol. Such an embodiment of the data element allows the inventive method to be used in existing telecommunication networks without adversely affecting the message transfer steps which are usual therein and are in some cases standardized. The inventive method can therefore be implemented very easily, quickly and inexpensively.

### BRIEF DESCRIPTION OF THE DRAWINGS

The invention is described below in detail with reference to the exemplary drawing, in which:

FIG. 1 shows an exemplary embodiment of a telecommunication network together with exemplary steps of the invention.

### DETAILED DESCRIPTION OF THE INVENTION

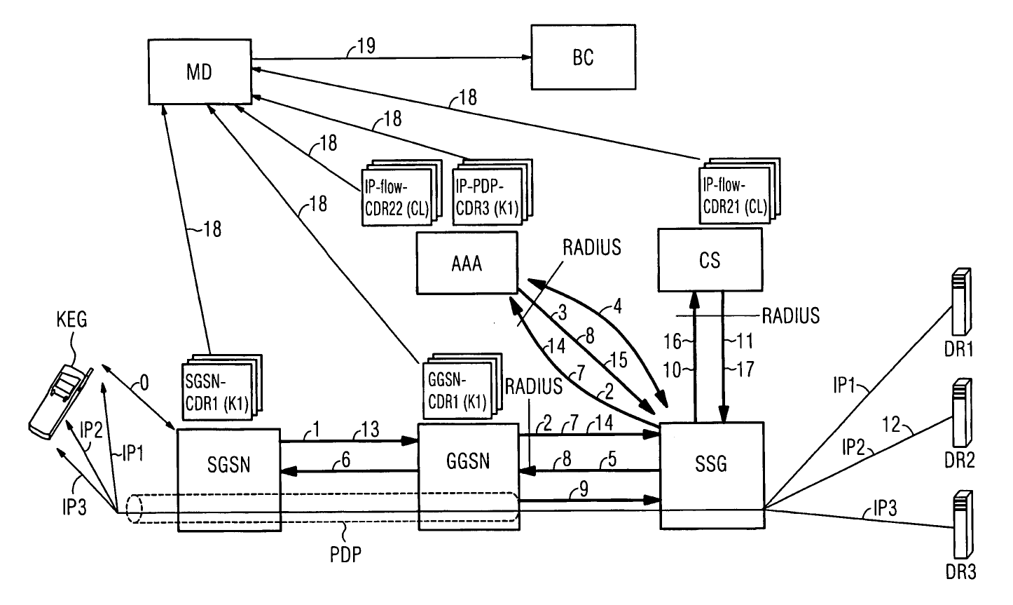

FIG. 1 shows a telecommunication network in the form of a mobile radio network which is connected to a service-using communication terminal KEG (in the form of a mobile telephone in this exemplary embodiment). This communication terminal KEG can be used to effect a service use by making use of a service which is provided by a service computer DR2. Such a service may be, by way of example, the delivery of video or audio files to the communication terminal KEG by the service computer DR2. To use the video data delivery service, for example, a data packet sequence IP2 is transferred between the service computer DR2 and the communication terminal KEG. In this case, the individual data packets in one data packet sequence may be transferred bidirectionally both from the communication terminal KEG to the service computer DR2 and in the opposite direction. In addition, the communication terminal KEG may also be used to use a further service from the service computer DR1. To this end, a data packet sequence IP1 is transferred between the communication terminal KEG and the service computer DR1. Similarly, the communication terminal KEG may also use a third service from a further service computer DR3; the service use is effected using a data packet sequence IP3 which is transferred between the communication terminal KEG and the service computer DR3.

The three data packet sequences IP1, IP2 and IP3 are transferred over long distances in the telecommunication network in the form of a data tunnel PDP (a “PDP context”, or Packet-Data-Protocol context). The data tunnel PDP is shown symbolically in the figure in the form of a pipe which comprises the three data packet sequences IP1, IP2 and IP3.

The text below will consider the data packet sequence IP2 by way of example. Data packets in this data packet sequence are sent from the communication terminal KEG in a known manner via an air interface, base station etc. (not shown) to a first network element in the form of a switching center SGSN (Serving GPRS Support Node) for data packets. This switching center SGSN routes the data packets to a network gateway node GGSN (Gateway GPRS Support Node). The network gateway node is situated in the switching network (core network) and, as a gateway in GPRS and UMTS networks, has the task of coordinating the data traffic between the switching network (Core Network) and external packet-switched transfer networks (Packet Data Network, PDN) in the mobile radio network. In the present exemplary embodiment, either the switching center SGSN or the network gateway node GGSN or both can adopt the function of the first network element. If the switching center SGSN or the network gateway node GGSN generate a first charging data record SGSN-CDR1 or GGSN-CDR1 later in the method procedure shown, the switching center SGSN or the network gate node GGSN adds a first unique identifier K1 to this first charging data record; it assigns this identifier to the charging data record. The identifier K1 contains GGSN-specific information, namely the worldwide-unique address (“GGSN address”) of the network gateway node GGSN in the format IPv4 or IPv6. In addition, the identifier K1 contains a data-packet-sequence-individual charging ID. The GGSN address together with the charging ID produce an identifier for the data tunnel PDP which is matchless and unique throughout the world. This identifier is assigned to the first charging data record as identifier K1.

The network gateway node GGSN sends the data packets to a service computer access gateway SSG (SSG =Service Selection Gateway). The switching center SGSN and the network gateway node GGSN cannot identify the data packet sequence IP2 as such, however, but instead they transmit the data packet sequence IP2 merely combined with the two other data packet sequences IP1 and IP3 within the data tunnel PDP. The network gateway node GGSN routes the data packet sequences IP1, IP2 and IP3 to the service computer access gateway SSG without distinguishing between the data packet sequences IP1, IP2 and IP3 or handling them separately. In this case, the service computer access gateway SSG is situated in an external packet switching data network from the point of view of the network gateway node GGSN. The service computer access gateway SSG is the first element capable of assigning the individual data packet sequences IP1, IP2 and IP3 to the individual services. The service computer access gateway SSG is used to forward the data packet sequence IP2 to the appropriate service computer DR2.

The service computer access gateway SSG is connected to a charging system CS via a RADIUS interface. This charging system CS is used to generate a charging data record IP-flow-CDR21 which relates to an individual data packet sequence (in the example the data packet sequence IP2). A further RADIUS interface connects the service computer access gateway SSG to an authorization network element AAA (AAA server). The authorization network element AAA generates a charging data record IP-flow-CDR22 which also relates to the exact data sequence IP2.

Within the context of the present invention, both the data record IP-Flow-CDR21 and the charging data record IP-Flow-CDR22 are second charging data records, which are generated alternatively or else both together in the inventive method.

The switching center SGSN generates a charging data record SGSN-CDR1 which contains charging information about the three data packet sequences IP1, IP2 and IP3 in summed form. Such charging information is “scope information” including information about a total scope for the transferred data in the data tunnel. Such scope information is, by way of example, the volume of data which is transferred via the data tunnel altogether during a particular period of time or the total time for which such a data tunnel is set up.

The network gateway node GGSN generates charging data records GGSN-CDR1 which are of similar design to the charging data record SGSN-CDR1. Both the charging data records SGSN-CDR1 and the charging data records GGSN-CDR1 are first charging data records within the context of the invention. In particular, the switching center SGSN and the network gateway node GGSN are able to generate the charging data records in parallel with one another over time.

As a further option, the authorization network element AAA can generate a further charging data record IP-PDP-CDR3, which contains charging information in summed form about the data tunnel PDP.

When they have been generated, the charging data records SGSN-CDR1, GGSN-CDR1, IP-Flow-CDR21, IP-Flow-CDR22 and IP-PDP-CDR3 are transferred to an identification node MD (Mediation Device). This identification node identifies that the charging data records cited are associated with the single service use from the service computer DR2 and hence are also associated with the transfer of the data packet sequence IP2. The identification node MD can then combine the charging information in the individual charging data records and can process it further, and can transmit a result for this combination and further processing to a billing center BC. Such a billing center BC may manage, by way of example, credit accounts for the communication terminal KEG which are debited with the appropriate charge sum. Alternatively, the billing center BC may be, by way of example, a computer in an external banking institute where an account is managed for the communication terminal KEG or for the holder thereof.

The text below gives a more precise explanation of the generation of the charging data records and the identification of the charging data records relating to a respective service use at the identification node MD.

When a user of the communication terminal KEG has selected a service from a menu displayed on the terminal, for example, and has sent a request for use of this service to the telecommunication network (arrow 0), the switching center SGSN sends a request for activation of the data tunnel PDP to the network gateway node GGSN (arrow 1: PDP Context Activation Request). The network gateway node GGSN then sends a request for authentication of the data tunnel PDP to the authorization network element AAA via the service computer access gateway SSG. This message is also used to transmit an identifier information item “Acct-Session-ID (PDP)” to the authorization network element AAA. The identifier information item “Acct-Session-ID (PDP)” contains the GGSN address and the charging ID or information about the GGSN address and the charging ID (message 2: RADIUS: Access Request (Acct-Session-ID(PDP))).

The authorization network element AAA receives the first identifier information, describing the first unique identifier K1, in the form of the “Act-Session-ID (PDP)” and packs this identifier information into a data element CL from the “RADIUS” data transfer protocol, which is in the form of the inherently known “Class” data element from the RADIUS protocol. According to the RADIUS specification, this data element CL cannot be altered again after it has been generated. It is thus unalterable after it has been generated and is therefore protected against inadvertent or deliberate alteration or falsification.

The authorization network element AAA then sends an approval message “Access Accept” back to the service computer access gateway SSG. Besides the title for the respective service, this approval message includes the data element CL (message 3: RADIUS: Access Accept (IP2, Class)). The data element CL is thus now available on the service computer access gateway SSG.

Next, service-specific data are transmitted from the authorization network element AAA to the service computer access gateway SSG, for example a title for the service and an internet address for the service computer (message 4: Service Profile Retrieval (IP2, Destination IP Address, [optionally containing an alternative AAA server respectively Charging Server]).

As the next step, the service computer access gateway SSG transmits the approval message 3 (which also includes the data element CL) to the network gateway node GGSN. The network gateway node GGSN stores the data element CL (message 5: RADIUS: Access Accept (forward of message #3 including class attribute)).

The network gateway node GGSN now opens the data tunnel PDP for the data transfer (message 6: Open GPRS Tunnel). In relation to this data tunnel PDP, the network gateway node GGSN next sends a request message for recording charging information relating to the data tunnel PDP to the authorization network element AAA, this request message also including, besides the identifier information “Acct-Session-ID (PDP)”, the data element CL (message 7: RADIUS: Accounting Start Request (Acct-Session-ID (PDP), class)). The authorization network element AAA is now “live” and ready to record charging information relating to the data tunnel PDP. This is communicated to the network gateway node GGSN using an acknowledgement message (message 8: RADIUS: Accounting Start Response).

A connection is then set up under the control of the network gateway node GGSN in order to transfer the data packet sequence IP2 between the service computer DR2 and the communication terminal KEG (message 12: Connection Set-up (IP-traffic)). The appropriate service data (that is to say, in the example, the video data which are to be transferred when providing the service) are now transferred from the service computer DR2 via the service computer access gateway SSG, the network gateway node GGSN and the switching center SGSN to the communication terminal KEG. In the course of this data transfer, the service computer access gateway SSG records charging information in the form of information about the exact data packet sequence IP2 transferred between the service computer 2 and the communication terminal KEG. Such charging information is, by way of example, transfer time information (“transferring the video data IP2 took 200 sec”) and/or data volume information (“transferring the video data IP2 involved a data volume of 65 MB”). This charging information is transferred to the charging system CS together with the data element CL. In this case, the charging information may be transferred at the start, during or at the end of the transfer of the data packet sequence IP2, and the charging system CS possibly calculates the relevant charging data by forming a difference between the recorded values at the end and the recorded values at the start of the transfer.

The charging system CS will ascertain the charging information relating to the data packet sequence IP2 from the transfer time information and data volume information and will generate the second charging data record IP2-Flow-CDR21 at a later time (see below) and will provide it with this charging information. In addition, the data element CL is appended to the second charging data record IP-Flow-CDR21.

Similarly, the service computer access gateway SSG alternatively or additionally sends the charging information relating to the data packet sequence IP2 to the authorization network element AAA, whereupon the latter (in a similar manner to the charging system CS) generates the second data record IP-Flow-CDR22 at a later time (see below) and appends the charging information and the data element CL to this data record.

As soon as the data packet sequence IP2 within the data tunnel PDP is transferred via the network gateway node GGSN, this network gateway node GGSN ascertains charging information about the data tunnel PDP which is used to transfer the data packet sequence IP2. This charging information thus contains information combined in summed form (called scope information above) about the data tunnel which transfers the one data packet sequence IP2 and the other data packet sequences IP1 and IP3. The network gateway node GGSN cannot distinguish between the various data packet sequences IP1, IP2 and IP3. The network gateway node GGSN will generate the first charging data record GGSN-CDR1 at a later time (see below), will write the charging information into this first data record and will assign the first unique identifier K1 to this first charging data record.

Similarly, the switching center SGSN also ascertains charging information relating to the data tunnel IP in combined and summed form during data transfer. The switching center SGSN is able to generate a charging data record SGSN-CDR1 having the character of a first charging data record at a later time (see below). This first charging data record SGSN-CDR1 is also provided with the first unique identifier K1.

As soon as the service use IP2 and possibly also the further service uses IP1 and IP3 from the service computers DR1 and DR3 have ended (particularly when the user of the communication terminal KEG wishes to end the service he is using, this ending of the service is to be achieved by clearing down the data tunnel PDP, and such a request for clearing down the data tunnel PDP is routed to the switching center SGSN), the switching center SGSN then sends a request for clearing down the data tunnel PDP to the network gateway node GGSN (message 13: PDP Context disconnect request). The switching center SGSN now generates the first charging data record SGSN-CDR1 (as already explained above). In addition, the network gateway node GGSN generates the charging data record GGSN-CDR1 (as already explained above). Alternatively, these charging data records may be generated at a later time, in which case the relevant charging information is stored at the switching center SGSN or at the network gateway node GGSN until this time.

Next, the network gateway node GGSN sends a request message 14 via the service computer access gateway SSG to the authorization network element AAA. This request message is used to transfer the information that the authorization network element AAA does not need to record any further charging information for the data tunnel. Besides the identifier information “Acct-Session-ID (PDP)” mentioned at the outset, this request message also contains the data element CL (message 14: RADIUS: Accounting Stop Request (Acct-Session-ID (PDP), class)).

The authorization network element AAA acknowledges this request message 14 using an acknowledgment message 15 (message 15: RADIUS: Accounting Stop Response). Next—and optionally—the authorization network element AAA generates the third charging data record IP-PDP-CDR3, to which the authorization network element AAA writes charging information which relates to the data tunnel PDP and which the authorization network element AAA has obtained from the network gateway node GGSN. The authorization network element AAA assigns the unique identifier K1 to this third charging data record IP-PDP-CDR3.

Cleardown of the data tunnel PDP prompts the service computer access gateway SSG to send a message 16 to the charging system CS asking it to terminate the current charging for the service use. This “Accounting Stop Request” message contains not only a title for the current service use and an “Acct-Session-ID (IP2)” relating to the data packet sequence IP2 but also the data element CL. The charging system CS acknowledges receipt of the message 16 using an acknowledgment message 17 (message 17: RADIUS: Accounting Stop Response). The charging system then generates the second charging data record IP-Flow-CDR21 (as already described above). The charging system may also generate this charging data record IP-Flow-CDR21 at a later time, however.

The authorization network element AAA now generates (as already described above) the charging data record IP-Flow-CDR22. The authorization network element AAA may also generate this charging data record IP-Flow-CDR22 at a later time, however.

By way of example, the charging data records may contain the following information:
SGSN-CDR1: PDP context: transfer time 200 s, data volume 300 MB
GGSN-CDR1: PDP context: transfer time 200 s, data volume 300 MB
IP-flow-CDR21: data packet sequence IP2: transfer time 200 s, data volume 65 MB
IP-flow-CDR22: data packet sequence IP2: transfer time 200 s, data volume 65 MB
IP-PDP-CDR3: PDP context: transfer time 200 s, data volume 300 MB

In a subsequent step, the charging data records generated SGSN-CDR1, GGSN-CDR1, IP-Flow-CDR21, IP-Flow-CDR22, IP-PDP-CDR3 are transferred to the identification node MD or are retrieved by it (message 18: CDR retrieval from network elements NE). The identification node MD now has these cited charging data records available (and possibly also others which do not relate to the service use IP2). The identification node now reads from the charging data records SGSN-CDR1, GGSN-CDR1 and IP-PDP-CDR3 the respective first unique identifier K1. From the charging data records IP-Flow-CDR21 and IP-Flow-CDR22, the identification node reads the respective data element CL and ascertains from the data element CL the first identifier information, which is “packed” in this data element (and which describes the first unique identifier K1, Acct-Session-ID (PDP)). Using the first identifier information and the first identifier, the identification system MD is able to establish that the five charging data records are associated with the service use IP2 (i.e. besides any other information also contain charging information relating to the data transfer using the data packet sequence IP2). The identification node MD is now able to combine this charging information, to remove redundant information, to assemble statistics or to prepare them in some other suitable fashion. The prepared charging information is then transmitted to the billing center BC in a message 19. This billing center BC then performs the actual debit operations on the account belonging to the owner, for example, of the communication terminal KEG (message 19: Data retrieval from Mediation Device MD). This ends the inventive method.

The text below is intended—to some extent in summary—to demonstrate other features or alternatives relating to the inventive method:

The data tunnel PDP (PDP context) may include one or more single data packet sequences (IP flows). The switching center SGSN and the network gateway node GGSN (which are both part of the “GPRS access network”) may only measure and ascertain charging information for the entire data tunnel PDP.

Charging information for individual data packet sequences (e.g. the data packet sequence IP2) is measured and determined in the IP core network at “IP flow level”. The distinction between the individual data packet sequences (IP flows: IP1, IP2 and IP3) is made by the service computer access gateway SSG. This service computer access gateway sends its charging information to the authorization server AAA or additionally or alternatively to the charging system CS (Charging Server). This charging system CS may be a charging system which operates “offline” (that is to say a charging system which creates the charging data records at a later time than the actual service use); alternatively, it may be a charging system which operates online in real time or a combined offline-online charging system. The authorization network element AAA or the charging system CS generates the charging data records at service level. Such charging data records used may also be log files containing the appropriate charging information.

Charging data records (IP-PDP-CDR3) or “log files” which are generated by the authorization unit AAA and are associated with the data tunnel PDP can be identified by the RADIUS attribute “Acct-Session-ID”. The latter comprises the GGSN address and the payment ID (Charging ID), which are connected in a UTF-8-coded hexadecimal data record.

The data transfer via the RADIUS interface (particularly between the service computer access gateway SSG and the charging system CS or the authorization network element AAA) conforms to standard in terms of use of the attribute “Acct-Session-ID”. In line with the invention, the “Acct-Session-ID (IP flow)” transferred in this case identifies a single data packet sequence (IP flow, e.g. IP2). This is done within the entire “user session”, which is identified by its own “Act-Session-ID (PDP)”, the ID being data-tunnel-PDP-based. In line with the invention, different forms are used for the data-tunnel-based ID and for the data-packet-sequence-based ID.

Upon first contact between the network gateway node GGSN and the authorization network element AAA, the identifier information or else the first unique identifier K1 is transferred to the authorization network element AAA. This is done in a manner which does not infringe relevant standards.

The authorization server AAA generates the “Class” attribute conforming to standard. This attribute applies for the entire “session”, i.e. for the entire life of the data tunnel PDP.

The “Class” attribute, which behaves as described in the radius specifications, is stored at the network gateway node GGSN and is appended to subsequent charging messages.

The service computer access gateway SSG generates a different “Accounting-Session-ID (IP1)”, “Accounting-Session-ID (IP2)” etc. for each individual data packet sequence IP1, IP2 and IP3. The messages 10 and 16 are respectively used to transfer this different Accounting-Session-ID and additionally the data element CL to the charging system. A similar thing happens with the data transfers from the service computer access gateway SSG to the authorization network element AAA. These service-specific Accounting-Session-IDs (which are also written to the charging data records concurrently) allow the identification node MD to assign the respective charging information item in the charging data record to one exact IP flow and hence to one actual service.

The inventive method allows the following alternatives and changes to be implemented:
a. The message pairs 10/11 and 16/17 can be sent from the service computer access gateway SSG to the AAA server; the identification node MD then requests no charging data records from the charging system.
b. The message pairs 10/11 and 16/17 can be sent to or come from an additional AAA server. This additional AAA server undertakes the role of the charging system CS.
c. The service computer access gateway SSG can be configured in a manner such that each different data packet sequence (which is to be transferred to the corresponding service computer) needs to be authorized by the charging system CS at the start of the service use. This configuration setting can preferably be used when the charging system CS is a charging system operating online in real time or is a combined offline-online charging system. In this case, the message pair 10/11 is preceded by a further message pair, which ensures that there is the option of prior authorization of the appropriate data packet sequence. The authorization is preferably provided by means of RADIUS messages “Access Request” and “Access Accept” (if successful) or “Access Reject” (in the event of rejection by the charging system CS).
d. The switching center SGSN or the network gateway node GSGN generates a first charging data record or just one of the two charging data records SGSN-CDR1 and GGSN-CDR1 is transferred to the identification node MD.
e. The charging data records are transferred directly to the billing center BC. This billing center performs the function of the identification node MD.
f. The charging system CS retrieves the charging data records from the switching center SGSN and/or from the network gateway node GGSN.

The inventive method has the following advantages, in particular: charging data records which are generated independently by various network elements in the communication network (and which may contain overlapping or redundant information) and relate to a single service use can be identified as being associated with this service use. This is advantageous particularly when the generation of charging data records cannot be suppressed on various network elements, but instead these charging data records are always generated as standard. The method does not clash with the relevant standards. Implementation is therefore simple and results in just minimal costs and implementation involvement. Particularly the core network elements (GGSN, SGSN) and the authorization network element (AAA) do not perform any steps which do not conform to standard.

Finally, the messages transferred in the course of the inventive method will be presented once again in summarized form. In this context, messages 2 to 5, 7, 8, 10, 11 and 14 to 17 are associated with the authorization messages (AAA & policy data flow). Messages 1, 6, 9, 12 and 13 are associated with the bearer messages (bearer traffic). Messages 10, 11, 16 and 17 are charging messages (charging flow). Messages 18 and 19 are used for retrieving the charging data records (CDR retrieval).
1. PDP Context activation request
2. RADIUS: Access Request (Acct-Session-ID (PDP)) via the SSG to the AAA server
3. RADIUS: Access Accept (Service List, class (contains Acct-Session-ID (PDP)))
4. Service Profile retrieval (Service Name (from Service List (IP1, IP2, IP3)), Destination IP Address, [optionally including an alternative AAA-server respectively Charging Server))
5. RADIUS: Access Accept (forward of message #3 including class attribute)
6. Open GPRS Tunnel
7. RADIUS: Accounting Start Request (Acct-Session-ID (PDP), class)
8. RADIUS: Accounting Start Response
9. Forward IP Request
10. RADIUS: Accounting Start Request (Service Name, Acct-Session-ID (IP flow), class)
11. RADIUS: Accounting Start Response
12. Connection Set-up (IP-traffic)
13. PDP Context disconnect request
13a. Write SGSN-CDR1, GGSN-CDR1
14. RADIUS: Accounting Stop Request (Acct-Session-ID (PDP), class) via the SSG to the AAA server
15. RADIUS: Accounting Stop Response
15a. Write IP-PDP-CDR3
16. RADIUS: Accounting Stop Request (Service Name(IP2), Acct-Session-ID (IP flow), class)
17. RADIUS: Accounting Stop Response
17a. Write IP-flow-CDR21, IP-flow-CDR22
18. CDR retrieval from network elements NE
19. CDR retrieval from Mediation Device
   Abbreviations used:
AAA Authentication, Authorization and Accounting
IP-PDP-CDR CDR or log file which are generated by an AAA server and contain information about a PDP context
CDR Charging Data Record
CS Charging System
GGSN-CDR GGSN generated CDR
GGSN Gateway GPRS Support Node
GPRS General Packet Radio Service
IP Internet Protocol
IP-Flow-CDR CDR, containing information about a particular data packet sequence
MD Mediation Device
PDP Packet Data Protocol, e.g. IP
SGSN-CDR SGSN generated CDR
SGSN Serving GPRS Support Node
SSG Service Selection Gateway
UMTS Universal Mobile Telecommunication System

1. A method for identifying charging data records which relate to a service use and are generated by various network elements in at least one telecommunication network, where a data packet sequence associated with the service use is transferred between a service-using communication terminal and a service-providing service computer via the at least one telecommunication network using a service computer access gateway, comprising:
generating a first charging data record which includes charging information relating to the data packet sequence;
assigning a first unique identifier to the first charging data record;
transferring first identifier information, which describes the first unique identifier, to an authorization network element via the service computer access gateway;
generating a data element from a data transfer protocol, which includes the identifier information and which is unalterable after it has been generated;
appending the data element to a second charging data record, which is generated on account of the transmission of the data packet sequence via the service computer access gateway;
transferring the first charging data record and the second charging data record to a data record identification node;
reading the first identifier information from the data element in the second charging data record; and
using the first identifier information in the second charging data record and the first identifier in the first charging data record to identify that the first charging data record and the second charging data record are associated with the same service use.

2. The method as claimed in claim 1, wherein the data element generated by the authorization network element is transferred to the service computer access gateway.

3. The method as claimed in claim 1, wherein the first charging data record generated is a first charging data record which includes the charging information about one data packet sequence and charging information about other data packet sequences which pass through the first network element and relate to the communication terminal in summed form.

4. The method as claimed in claim 3, wherein the first charging data record includes the charging information in a form of summed transfer time information and/or summed data volume information.

5. The method as claimed in claim 1, wherein the second charging data record generated is a second charging data record which includes charging information about the data packet sequence transferred between the communication terminal and the service computer.

6. The method as claimed in claim 1, wherein the second charging data record is generated by transmission of the data packet sequence via the service computer access gateway prompting the service computer access gateway to transmit the data element to a charging system, which generates the second charging data record and appends the data element to the second charging data record.

7. The method as claimed in claim 6, wherein at a start and/or end of transfer of the data packet sequence the service computer access gateway transmits to the charging system, together with the data element, transfer time information and/or data volume information relating to the data packet sequence, and the charging system uses the transfer time information and/or data volume information to generate the second charging data record.

8. The method as claimed in claim 1, wherein the second charging data record is generated by virtue of transmission of the data packet sequence via the service computer access gateway prompting the service computer access gateway to transmit the data element to the authorization network element, which generates the second charging data record and appends the data element to the second charging data record.

9. The method as claimed in claim 8, at the start and/or end of transfer of the data packet sequence the service computer access gateway transmits to the authorization network element, together with the data element, transfer time information and/or data volume information relating to the data packet sequence, and the authorization network element uses the transfer time information and/or data volume information to generate the second charging data record.

10. The method as claimed in claim 1, wherein setup and/or cleardown of a data tunnel for transferring one data packet sequence prompts the first network element to transmit to the authorization network element, together with the identifier, transfer time information relating to the data tunnel and/or data volume information relating to the data tunnel, and the authorization network element uses the transfer time information and/or data volume information to generate a third charging data record and assigns the identifier to the third charging data record.

11. The method as claimed in claim 10, wherein
the third charging data record is transferred to
the data record identification node,
the data record identification node reads the identifier from the third charging data record, and
the identifier is used to identify that the third charging data record, the second charging data record and the first charging data record are associated with the same service use.

12. The method as claimed in claim 1, wherein the first network element used is a Serving GPRS Support Node.

13. The method as claimed in claim 1, wherein the first network element used is a Gateway GPRS Support Node.

14. The method as claimed in claim 1, wherein the authorization network element used is an Authentication, Authorization and Accounting Server.

15. The method as claimed in claim 1, wherein the first identifier information comprises an address which identifies the first network element and an identity which identifies the data tunnel.

16. The method as claimed claim 1, wherein as the data element which includes the identifier information, the authorization network element generates a class data element designed based on a RADIUS data transfer protocol.
